(19) United States
(12) Patent Application Publication
(10) Pub. No.: US 2005/0127063 A1
(43) Pub. Date: Jun. 16, 2005

(54) Saucepan

(76) Inventor: Roberto Vincenzo Garziera, Appiano Gentile (Como) (IT)

Correspondence Address: Kirschstein, Ottinger, Israel & Schiffmiller, P.C., 489 Fifth Avenue, New York, NY, 10017-6105, US

(21) Appl. No.: 11/008,366

(22) Filed: Dec. 9, 2004

(30) Foreign Application Priority Data
Dec. 12, 2003 (IT) MI2003A-002432

(51) Int. Cl. F27D 11/00

(52) U.S. Cl. 219/440

(57) ABSTRACT

A saucepan (10) comprises at least a substantially cylindric vessel (11); at least an attachment lug (30) coupled to the walls of said vessel (11); at least a handle (20), articulated to said attachment lug (30) to be easily arranged at at least two positions, one of which is a raised position, in which the handle radially extends from the walls of said vessel (11), and the other being a lowered position, in which the handle is arranged adjoining to said walls, thereby allowing the saucepan (10) to be arranged inside another saucepan having a like shape and a slightly larger size; at least a locking device for locking said handle (20) at at least said raised position by affecting said attachment lug (30), including at least a lever (50) coupled to said handle (20) and movable with respect to the latter.

### BACKGROUND OF THE INVENTION

Saucepans conventionally comprise a vessel including one or more handles, which radially extend from the walls of said vessel and are firmly coupled thereto.

Said handles, however, frequently hinder a proper and efficient arrangement of the saucepan. This occurs, by way of a non limitative example, as the saucepans are packaged and shipped, or as they are arranged in washdishers, refrigerators, furniture pieces, on shelves and so on.

A feature which is negatively affected by said handles is, as well known, the stacking of the saucepans, or, more specifically, the possibility of arranging saucepans within one another.

A saucepan set designed for meeting most common culinary requirements conventionally comprises, inter alia, a number of saucepans, also called “casseroles or stewpans”, having a like configuration, mostly a cylindric one, and increasing diameters starting from the smallest one, which are slightly different from one another. By way of a non limitative example, a saucepan set could also comprise a series of casseroles having diameters of 120, 160, 200, 240, 280, 320 millimeters. On the other hand, said saucepans conventionally comprise two saucepan handles which radially extend for an extension varying, by way of a non limitative example, from 40 to 80 millimeters.

Thus, some saucepan set forming a saucepans could also be arranged, in general, in an increasing size order, each within a next one, if exclusively the cooking vessel size would be considered; however, this is not possible because of the provision of the saucepan handles.

A prior solution for overcoming the above mentioned drawback is that of providing the saucepan with removable handles.

However, such a solution is affected by several drawbacks: in fact, it provides, sometimes, an unreliable gripping; compels to use rather large handles and attachment lugs; involves a separated handling of the saucepans and their handles. Another prior solution for limiting the occupied space volume due to the provision of the projecting handles is that of providing saucepans with pivoted handles. Such a handle usually comprises metal moldings, pivoted at end portions thereof, which are lowered under their weight, and must be raised each time they must be gripped. Such a solution is sometimes adopted, for example, in oven saucepans, having a substantially rectangular shape; however, it provides an unreliable and difficult to be obtained gripping for the most part of other gastronomic uses.

### SUMMARY OF THE INVENTION

Accordingly, an object of the present invention is to overcome the above mentioned drawbacks and, more specifically, to provide such a saucepan having either one or two saucepan handles which can stably assume a raised position at which, by radially extending from the walls of said saucepan, they can be easily and reliable gripped, and a lowered position, at which, being arranged as far as possible near to the walls of said saucepan, they greatly reduce the occupied space of the latter, while allowing the saucepan to be arranged inside another saucepan having a like shape and a slightly larger size.

Another object of the present invention is to provide such a saucepan having either one or two articulated handles, which can be made in a simple and unexpensive manner.

According to one aspect of the present invention, the above mentioned and yet other objects are achieved by a saucepan according to claim 1. Further features being defined in the dependent claims.

### BRIEF DESCRIPTION OF THE DRAWINGS

Further characteristics and advantages of a saucepan according to the present invention will become more apparent hereinafter from the following disclosure, given by way of a non limitative example, with reference to the schematic accompanying drawings, where:

FIG. 1 is an isometric view of a saucepan according to the invention having two handles one of which is arranged in a raised position and the other of which is arranged in a lowered position;

FIG. 2 is a top plan view of a saucepan according to the invention, into which a like saucepan having a slightly smaller size has been arranged;

FIG. 3 is a cross-sectional view, taken along a diameter joining the centerlines of the handles, of the saucepan shown in FIG. 2, into which a non cross-sectioned like saucepan having a slightly smaller size has been arranged;

FIG. 4 is an isometric view of an attachment lug-handle assembly according to the invention, as cross-sectioned along an axis slightly spaced from the centerline;

FIG. 5 shows several isometric views of a possible embodiment of an attachment lug for a saucepan according to the invention;

FIG. 6 is an isometric view of a possible embodiment of a handle for a saucepan according to the invention;

FIG. 7 is an isometric view of a possible embodiment of a locking lever for a saucepan according to the invention;

FIG. 8 is an isometric and orthogonal cross-section view substantially taken along a symmetry axis, of the assembly comprising the attachment lug of FIG. 5, the saucepan handle of FIG. 6 and lever of FIG. 7, in an assembled relationship, the handle being shown in a raised position;

FIG. 9 is a further isometric cross-section view passing through the axis of the hinge of the assembly of FIG. 8, the saucepan handle being shown in a lowered position; and

FIG. 10 is a further isometric view of the assembly comprising the handle of FIG. 6 and the lever of FIG. 7, said lever being partially withdrawn.

### DESCRIPTION OF THE PREFERRED EMBODIMENTS

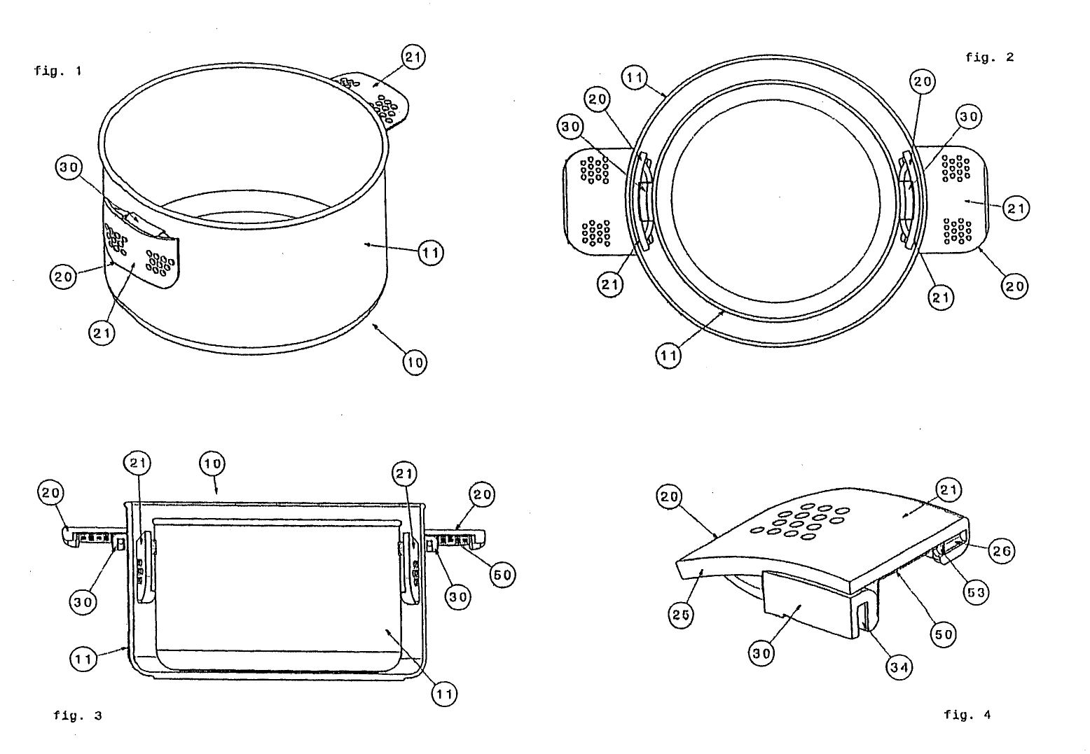

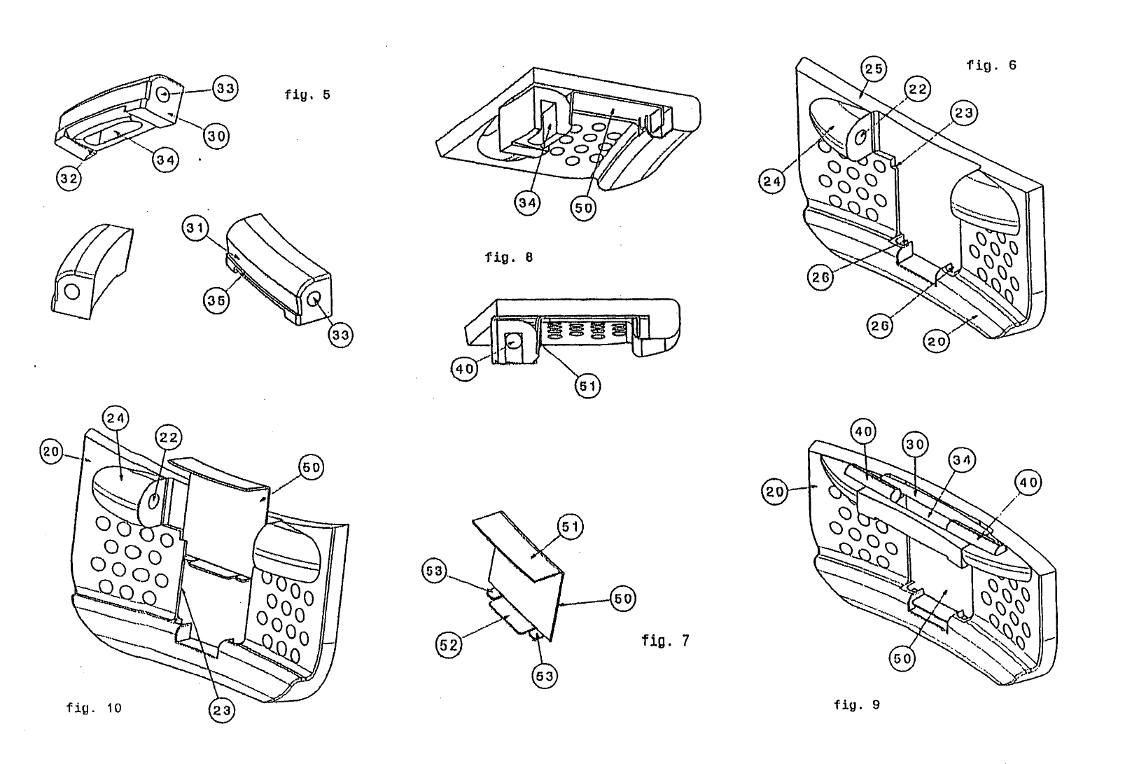

With reference to FIGS. 1 to 10, they show a saucepan 10, comprising a substantially cylindric saucepan vessel 11, having vessel walls to which are coupled, at a suitable height, two attachment lugs 30, arranged at diametrically opposite positions. As shown in FIGS. 5 and 9, said attachment lugs comprise two holes 33, a slot 34, a recess 31 and a further recess 32. Handles 20 are coupled, through holes 22 formed in embossed or bulged portions 24, to the attachment lugs 30, by coupling pins 40 passing through holes 33. The slot 34 allows said coupling pins 40 to be easily engaged.

As shown in FIGS. 2 and 3, the assembly comprising the handles 20, at a lowered position of the latter, coupled to the attachment lugs 30 connected to the vessel 11 is advantageously so designed as to be delimited by a cylindric surface, concentric to said vessel 11, coinciding with the surface 21, thereby further reducing the assembly occupied space while allowing the saucepan 10 to be arranged inside another like saucepan having a slightly larger diameter.

In this connection it should be apparent that, upon having coupled the attachment lugs 30 to the walls of the vessel 11 and applied the handles 20, the latter will be able of performing, with respect to said walls, a movement limited to a rotary displacement about the axes of the coupling pins 40. Thus, said handles 20 can be brought to a lowered position, at which they are abutted against the walls of the vessel 11, and a raised position, at which they will extend radially of said walls, to a point at which the extrados 25 will contact said walls.

As shown in FIGS. 4 and 8, a device comprising, by way of a non limitative example, the lever 50 would allow to lock said handles 20 at said raised position, thereby making the latter as a stable position and preventing said handles from being undesirably bent, by way of a non limitative example, as the saucepan is reversed from empting its contents.

In a preferred embodiment, shown in FIGS. 4, 7 and 8, said device comprises a metal lever 50, which, by way of a non limitative example can be made by a shearing and pressing method, including lever tongues 51, 52 and 53 engaged in the slot 23 of the handle 20, as shown in FIG. 10, with a slight clearance, thereby sliding with respect to said handle 20.

Urging springs having a suitable resilient constant, as engaged in a cavity 26, will provide a reaction force against the displacement of the lever 50, by affecting the lever tongues 53 and urging said lever 50 in the direction of the attachment lug 30. As shown in FIG. 8, by raising the handle 20, the lever 50, by re-engaging in the recess 31 formed on the attachment lugs 30, and bearing on the ridge 35, will lock the handle 20 at a non use position, which is substantially parallel to the bottom of the vessel 11.

In order to unlock the handle 20, the lever 50 must be outward pressed (more specifically in a radial direction so as to move it away from the vessel 11), by affecting the lever tongue 52, to cause the handle to downward turn. A recess 32, formed on the attachment lug 30, engages the lever tongue 51 therein as the handle is in a lowered position, so as to firmly set it in this position.

The above saucepan embodiment according to the present invention, as disclosed, is well adapted, by way of a non limitative example, for making metal cast or pressed single-block attachment lugs, and thermoplastic resin handles (by way of a non limitative example, phenolic resins).

It should be apparent that the above illustrated embodiment of the saucepan according to the invention represents only one of a lot of possible embodiments.

From the disclosure, the features of the saucepan, as well as its advantages, will be self-evident and, more specifically:
a small occupied space or size;
a possibility of arranging a saucepan inside another like saucepan having a slightly larger size;
a self-evident and reliable use;
a simple construction and assembling.

Finally, it should be apparent that the disclosed saucepan would be susceptible to several modifications and variations, all coming within the scope of the invention; moreover, all the details can be replaced by other technically equivalent elements. In practicing the invention, the used materials, as well as the contingent shape and size, can be any depending on technical requirements.

The invention scope, accordingly, will be defined by the accompanying claims.

1. A saucepan (10) comprising at least a substantially cylindric vessel (11) having vessel walls; at least an attachment lug (30) coupled to said walls of said vessel (11); at least a saucepan handle (20), articulated with respect to said attachment lug (30) to be arranged, in a simple manner, at at least two positions, one of which is a raised position at which said handle radially extends from said walls of said vessel (11), and the other is a lowered position, at which said handle is arranged adjoining said walls, thereby allowing said saucepan (10) to be arranged inside another saucepan having a like shape and a slightly larger size; at least a locking device for locking said handle (20) at at least said raised position by affecting said attachment lug (30), said device comprising at least a lever (50) coupled to said handle (20) and movable with respect to said handle (20).

2. A saucepan according to claim 1, wherein said handle (20) comprises at least an urging spring urging said lever (50).

3. A saucepan according to claim 1, wherein said attachment lug (30) is made as a metal pressed or cast single block, said handle (20) being made of thermoplastic resins, and said lever (50) being made of a metal sheet element.

4. A saucepan according to claim 1, wherein said attachment lug (30) comprises recesses (31 and (32) designed for engaging said lever (50) therein as said handle (20) is arranged either in a raised or lowered position thereof.
